(19) United States
(12) Patent Application Publication
(10) Pub. No.: US 2026/0039201 A1
(43) Pub. Date: Feb. 5, 2026

(54) POWER CONVERSION DEVICE

(71) Applicant: MetaPWR Electronics Co., Ltd., Shanghai (CN)

(72) Inventors: Da Jin, Shanghai (CN); Yahong Xiong, Shanghai (CN); Qinghua Su, Shanghai (CN)

(73) Assignee: MetaPWR Electronics Co., Ltd., Shanghai (CN)

(21) Appl. No.: 19/284,681

(22) Filed: Jul. 30, 2025

(30) Foreign Application Priority Data
Jul. 31, 2024 (CN) 202411043835.5

(51) Int. Cl. H02M 3/158; H01F 27/24; H01F 27/28; H02M 1/00; H02M 3/00

(52) U.S. Cl. CPC H02M 3/158; H01F 27/24; H01F 27/28; H02M 1/0064; H02M 3/003

(57) ABSTRACT

The application discloses a power conversion device, comprising a circuit substrate, an input positive terminal, an input negative terminal, an output positive terminal, an output negative terminal, a first circuit unit and a second circuit unit. On one hand, stable output and adjustable control of the output voltage can be achieved by setting the control time sequence of the switches in each circuit unit and utilizing four control signals. On the other hand, through arrangement of components, the size and loss of the power conversion device are reduced. On the other hand, the metal block is arranged on the surface of the circuit substrate, the negative terminal and the output negative terminal are short-circuited, and heat generated by the component is dissipated by arranging the metal block.

### CROSS-REFERENCE TO RELATED APPLICATION

This application claims the priority benefit of Chinese patent application 202411043835.5 filed on Jul. 31, 2024. The entirety of the above-mentioned patent application is hereby incorporated by reference herein and made a part of this specification.

### BACKGROUND

With the development of artificial intelligence, the power requirements of an intelligent data processing chip, such as a GPU/CPU/TPU and the like (collectively referred to as XPU) are higher and higher, so that the power of the server is greatly increased, the power supply voltage of the server system board gradually rises from 12V to 48V. The two-stage voltage reduction circuit architecture gradually becomes mainstream when the power supply voltage of the serve system board is 48V.

The intermediate bus conversion device in the two-stage voltage reduction circuit is the conversion device for transforming the voltage between the input bus and the output bus, and comprises the ratio of the input voltage to the output voltage including a fixed gain ratio or an unfixed gain ratio. The intermediate bus conversion with an unfixed gain ratio converts a range of 40-60V input voltage of the server system board into a stable 12V output voltage which used for supplying a memory module load in the serve system board, a voltage regulator load for supplying the intelligent chip, and a fan load. With the power consumption of the serve system board is larger and larger, the intermediate bus conversion with a stable 12V output voltage needs to provide increasingly large power, and increasingly high requirements of power density and heat dissipation.

For the above applications, the present invention provides a series of means, comprising: 1) stable output and adjustable control of the output voltage can be achieved by connecting two circuit units in parallel and simplifying control strategy. 2) Through arrangement of components, the size and loss of the power conversion device are reduced. 3) The metal block is arranged on the surface of the circuit substrate, the negative end and the output negative end are short-circuited, and heat generated by the component is dissipated by arranging the metal block.

### SUMMARY

In view of the above, one of the objectives of the application is to provide a power conversion device, comprising an input positive terminal, an input negative terminal, an output positive terminal, an output negative terminal and a circuit unit, wherein the circuit unit comprises a first circuit unit and a second circuit unit;
the first circuit unit and the second circuit unit are electrically connected in parallel and bridged between the input positive terminal and the input negative terminal; and each circuit unit comprises an upper switch, a middle switch, a first lower switch, a second lower switch, a three-port magnetic assembly and a flying capacitor; the upper switch and the middle switch are electrically connected to an upper node, and the upper switch is bridged between the input positive terminal and the upper node; the middle switch and the first lower switch are electrically connected to a first lower node, and the first lower switch is bridged between the first lower node and the input negative terminal; the flying capacitor and the second lower switch are electrically connected to a second lower node, the second lower switch is bridged between the input negative terminal and the second lower node, and the flying capacitor is bridged between the upper node and the second lower node; the three-port magnetic assembly is electrically connected with the first lower node, the second lower node and the output positive terminal;
wherein the group of control signals comprises a first control signal, a second control signal, a third control signal and a fourth control signal; the first control signal is used for controlling on and toff of the upper switch of the first circuit unit and the middle switch of the second circuit unit; the second control signal is used for controlling on and off of the middle switch of the first circuit unit and the upper switch of the second circuit unit; the third control signal is used for controlling on and off of the second lower switch of the first circuit unit and the first lower switch of the second circuit unit; the fourth control signal is used for controlling on and off of the first lower switch of the first circuit unit and the second lower switch of the second circuit unit;
the first control signal and the second control signal are staggered by 180 degrees, the third control signal is complementary to the first control signal, and the fourth control signal is complementary to the second control signal.

Preferably, wherein a duty ratio of each control signal is any value between 0 and 1.

Preferably, wherein the three-port magnetic assembly comprises two transformer windings and an inductor winding; first ends of the two transformer windings are electrically connected with the first lower node and the second lower node of the circuit unit respectively, second ends of the two transformer windings are electrically connected with a first end of the inductor winding, and a second end of the inductor winding is electrically connected with the output positive terminal.

Preferably, wherein the three-port magnetic assembly comprises two transformer windings; first ends of the two transformer windings are electrically connected with a first lower node and a second lower node of the circuit unit respectively, and second ends of the two transformer windings are electrically connected with the output positive terminal respectively.

Preferably, wherein the first end of one transformer winding in each three-port magnetic assembly and the second end of the other transformer winding are dotted terminals.

Preferably, the power conversion device further comprises a transformer magnetic core and an inductor magnetic core; and the transformer magnetic core comprises two transformer side columns, a transformer middle column and two transformer magnetic substrates; the two transformer side columns and one transformer middle column are arranged between the two transformer magnetic substrates, and the transformer middle column is arranged between the two transformer side columns; and the inductor magnetic core comprises two inductor side columns, an inductor middle column and two inductor magnetic substrates; the two inductor side columns and one inductor middle column are arranged between the two inductor magnetic substrates, and the inductor middle column is arranged between the two inductor side columns; the first end of one transformer winding and the first lower switch are electrically connected to the first lower node, the first end and the second lower switch of the other transformer winding are electrically connected to the second lower node, and the second ends of the two transformer windings are short-circuited; and the two transformer windings in each circuit unit are wound around one transformer side column in the same direction from the first lower node to the second lower node; and the inductor winding in the first circuit unit is wound around one inductor side column in a first direction, and the inductor winding in the second circuit unit is wound around the other inductor side column in a second direction.

Preferably, sectional areas of the two transformer side columns are the same, and the sectional area of the transformer middle column is smaller than that of the transformer side column; sectional areas of the two inductor side columns are the same, and the sectional area of the inductor middle column is smaller than that of the inductor side column.

Preferably, the sectional area of the column in the transformer is smaller than 0.6 times of the sectional area of the side column of the transformer; and the sectional area of the column in the inductor is smaller than 0.6 times of the sectional area of the inductor side column.

A power conversion device, comprising a circuit substrate, an input end, an output end, a switch element, a magnetic assembly and a metal block; the input end comprises an input positive terminal and an input negative terminal, and the output end comprises an output positive terminal and an output negative terminal; the magnetic assembly comprises a winding and a magnetic core, and the winding is arranged in the circuit substrate and/or a surface of the circuit substrate; the magnetic assembly is bridged between the input end and the output end through the switch element; the metal block is arranged on the surface of the circuit substrate and is in short connection with the input negative terminal and the output negative terminal, and the magnetic assembly is arranged between the input end and the output end;

The metal block is disposed adjacent to one side of the magnetic assembly.

Preferably, the power conversion device further comprises a heat dissipation metal block arranged on the surface of the circuit substrate and arranged adjacent to a drain electrode of the switch element and used for dissipating heat generated by the switch element.

Preferably, wherein a height of the metal block and/or the heat dissipation metal block is equal to a height of the switch element.

Preferably, wherein the metal block and/or the heat dissipation metal block are copper materials.

A power conversion device, comprising a circuit substrate, a circuit unit, an input end and an output end; the circuit unit comprises a first circuit unit and a second circuit unit; each circuit unit comprises an upper switch, a middle switch, a first lower switch and a three-port magnetic assembly; the upper switch, the middle switch and the first lower switch of each circuit unit are sequentially connected in series; the input end comprises an input positive terminal and an input negative terminal, and the output end comprises an output positive terminal and an output negative terminal;
the circuit substrate comprises an upper surface and a lower surface which are opposite to each other, and the upper surface comprises a switch area and a magnetic assembly area; the switch area is used for arranging the upper switch, the middle switch and the first lower switch, and the magnetic assembly area is used for arranging the three-port magnetic assembly;
the input end, the switch area, the magnetic assembly area and the output end are sequentially arranged in the same direction;
the upper switch, the middle switch and the first lower switch in each circuit unit are sequentially arranged in the same direction; and each first lower switch is arranged adjacent to the magnetic assembly area.

Preferably, each circuit unit further comprises a second lower switch, and a source electrode of the second lower switch is connected with a source electrode of the first lower switch in parallel; and the second lower switch is arranged in the switch area and is arranged adjacent to the magnetic assembly area.

Preferably, wherein the upper switch, the middle switch, the first lower switch and the second lower switch in each circuit unit are sequentially arranged in the same direction.

Preferably, wherein the upper surface further comprises an output area, the output area is used for setting an output capacitor, and the output area is arranged adjacent to the output end.

Preferably, wherein the lower surface comprises an input capacitor area, a flying capacitor area, a magnetic assembly area and an output area; the input capacitor area is used for setting an input capacitor, the flying capacitor area is used for setting a flying capacitor, the magnetic assembly area is used for arranging a three-port magnetic assembly, and the output area is used for setting an output capacitor; the input end, the magnetic assembly area and the output area are sequentially arranged in the same direction on the lower surface; the input capacitor area and the flying capacitor area are both arranged between the input end and the magnetic assembly area; and the input capacitor area of the first circuit unit, the flying capacitor area of the first circuit unit, the input capacitor area of the second circuit unit and the flying capacitor area of the second circuit unit are sequentially arranged in the direction from the input positive terminal to the input negative terminal.

Preferably, each three-port magnetic assembly comprises two transformer windings; and the three-port magnetic assemblies share one transformer magnetic core; and the transformer magnetic core comprises two transformer side columns, a transformer middle column and two transformer magnetic substrates; the two transformer side columns and one transformer middle column are arranged between the two transformer magnetic substrates, and the transformer middle column is arranged between the two transformer side columns; a first end of one transformer winding and the first lower switch are electrically connected to a first lower node, a first end of the other transformer winding and the second lower switch are electrically connected to a second lower node, and second ends of the two transformer windings are short-circuited; and the two transformer windings in each circuit unit are wound around one transformer side column in the same direction from the first lower node to the second lower node respectively.

Preferably, the first lower switch and the second lower switch in the same circuit unit are arranged close to the same transformer side column.

Preferably, the arrangement direction of the upper switch, the middle switch and the first lower switch in each circuit unit is the same as a winding direction of the two transformer windings around a side column from the first lower node to the second lower node.

Preferably, wherein each three-port magnetic assembly further comprises an inductor winding, and two inductor windings share one inductor magnetic core; and each inductor winding is bridged between a connection point of the transformer windings and an output positive terminal; the inductor magnetic core comprises two inductor side columns, an inductor middle column and two inductor magnetic substrates; the two inductor side columns and one inductor middle column are arranged between the two inductor magnetic substrates, and the inductor middle column is arranged between the two inductor side columns; and the inductor winding in the first circuit unit is wound around one inductor side column in a first direction, and the inductor winding in the second circuit unit is wound around the other inductor side column in a second direction.

Compared with the prior art, the application has the following beneficial effects:

(1) The application provides a power conversion device. On one hand, the stable output and adjustable control of the output voltage can be achieved by setting the control time sequence of the switches in each circuit unit and utilizing four control signals.

(2) On the other hand, through arrangement of components, the size and loss of the power conversion device are reduced. The metal block is arranged on the surface of the circuit substrate, the input negative terminal and the output negative terminal are short-circuited, and heat generated by the component is dissipated by arranging the metal block.

### DESCRIPTION OF DRAWINGS

FIG. 1 is a schematic circuit diagram of a power conversion device;

FIG. 2A is a control policy when the duty cycle is less than 0.5;

FIG. 2B is a control policy when the duty cycle is greater than 0.5;

FIG. 3 is a winding mode of a magnetic assembly;

FIG. 4A is a three-dimensional top view of a power conversion device;

FIG. 4B is a bottom perspective view of the power conversion device;

FIG. 4C is a top exploded view of the power conversion device.

### DETAILED DESCRIPTION

One of the cores of the application is to provide a power conversion device. On one hand, the stable output and adjustable control of the output voltage can be achieved by setting the control time sequence of the switches in each circuit unit and utilizing four control signals. On the other hand, through arrangement of components, the size and loss of the power conversion device are reduced. On the other hand, the metal block is arranged on the surface of the circuit substrate, the input negative terminal and the output negative terminal are short-circuited, and heat generated by the component is dissipated by arranging the metal block.

According to the technical scheme in the embodiment of the application, the technical scheme in the embodiment of the application is clearly and completely described below in combination with the drawings in the embodiment of the application, obviously, the described embodiments are only a part but not all of the embodiments of the present application all other embodiments obtained by a person of ordinary skill in the art based on the embodiments of the present application without creative efforts shall fall within the protection scope of the present application.

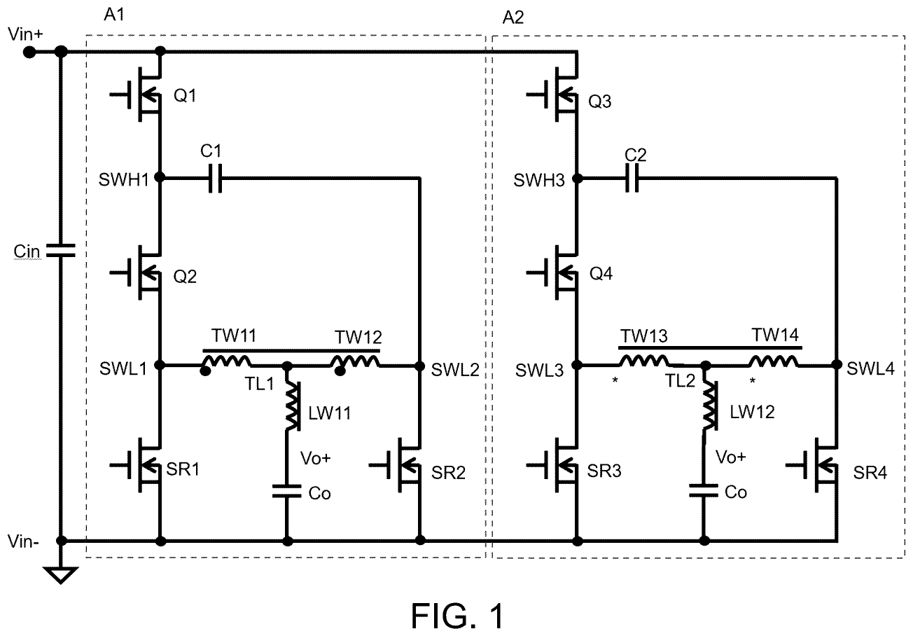

The application discloses a power conversion circuit, and the schematic diagram is as shown in FIG. 1. The power conversion circuit comprises an input end and an output end, the input end comprises an input positive terminal Vin+ and an input negative terminal Vin−, and the output end comprises an output positive terminal Vo+ and an output negative terminal Vo− (equivalent to an input negative terminal Vin−). The power conversion circuit further comprises an input capacitor Cin and an output capacitor Co, wherein the input capacitor Cin is bridged between the input positive terminal Vin+ and the input negative terminal Vin−, and the output capacitor Co is bridged between the output positive terminal Vo+ and the input negative terminal Vin−. The power conversion circuit shown in FIG. 1 further comprises two circuit units A1 and A2, and each circuit unit comprises an upper switch, a middle switch, two lower switches, a flying capacitor and a three-port magnetic unit. Circuit topology and connection are described by taking the circuit unit A1 as an example. The circuit unit A1 comprises an upper switch Q1, a middle switch Q2, a first lower switch SR1, a second lower switch SR2, a flying capacitor C1 and a first three-port magnetic unit. In the embodiment, the first three-port magnetic unit comprises a first transformer winding TW11, a first transformer winding TW12 and a first inductor winding LW11, wherein the first transformer winding TW 11 and the first transformer winding TW12 are mutually coupled or wound on the same magnetic column. The upper switch Q1, the middle switch Q2 and the first lower switch SR1 are sequentially connected in series to form a three-switch bridge arm; the source of the upper switch Q1 and the drain of the middle switch Q2 are electrically connected to the upper node SWH1; and the source of the middle switch Q2 and the drain of the first lower switch SR1 are electrically connected to the first lower node SWL1. The first end of the flying capacitor C1 is electrically connected with the upper node SWH1, the second end of the flying capacitor C1 and the drain of the second lower switch SR2 are electrically connected to the second lower node SWL2. And the three-switch bridge arm is bridged between the input positive terminal Vin+ and the input negative terminal Vin−; the drain electrode of the upper switch Q1 is electrically connected with the input positive terminal Vin+; and the source electrode of the first lower switch SR1 and the source electrode of the second lower switch SR2 are both electrically connected with the input negative terminal Vin−. The first end of the first transformer winding TW11 is electrically connected to the first lower node SWL1, and the first end of the first transformer winding TW12 is electrically connected to the second lower node SWL2. The second end of the first transformer winding TW11, the second end of the first transformer winding TW12 and the first end of the first inductor winding LW11 are electrically connected to the connection point TL1, and the second end of the first inductor winding LW11 is electrically connected to the output positive terminal Vo+. Similarly, the circuit unit A2 comprises an upper switch Q3, a middle switch Q4, a first lower switch SR3, a second lower switch SR4, a flying capacitor C2 and a second three-port magnetic assembly. In the embodiment, the second three-port magnetic assembly comprises a second transformer winding TW13, a second transformer winding TW14 and a second inductor winding LW12, wherein the second transformer winding TW13 and the second transformer winding TW14 are mutually coupled or wound on the same magnetic column. The circuit unit A2 also comprises an upper node SWH3, a first lower node SWL3, a second lower node SWL4 and a connection point TL2; the connection mode can refer to the circuit unit A1, and details are not described herein again. In the embodiment, the first transformer winding TW11 and the first transformer winding TW12 are wound on the same magnetic column; the first end of the first transformer winding TW11 and the second end of the first transformer winding TW12 are with same polarity and are marked as point ends. The second transformer winding TW13 and the second transformer winding TW14 are wound on the same magnetic column; the first end of the second transformer winding TW13 and the second end of the second transformer winding TW14 are with same polarity and are marked as * ends.

In other embodiments, the three-port magnetic unit may also include only two transformer windings coupled to each other without including an inductor winding; and a connection point between the two transformer windings is shorted to the output positive terminal Vo+.

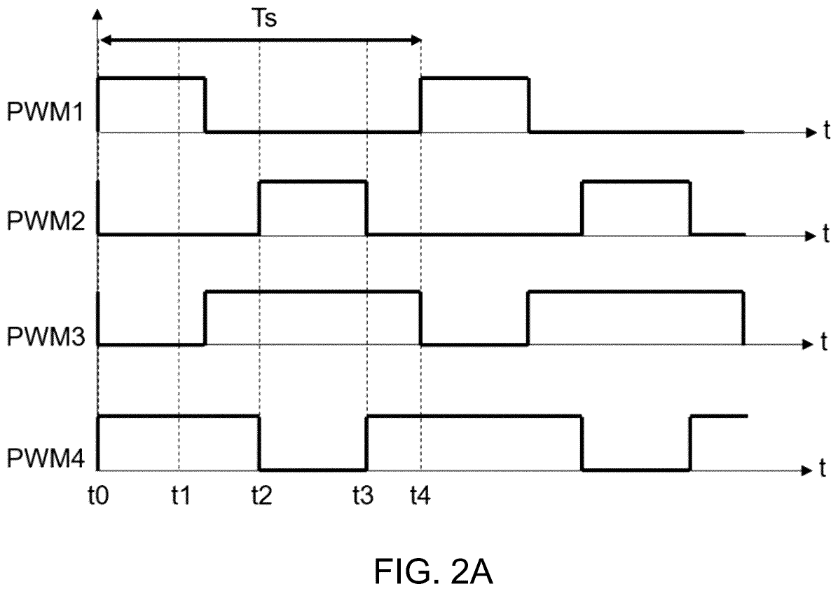

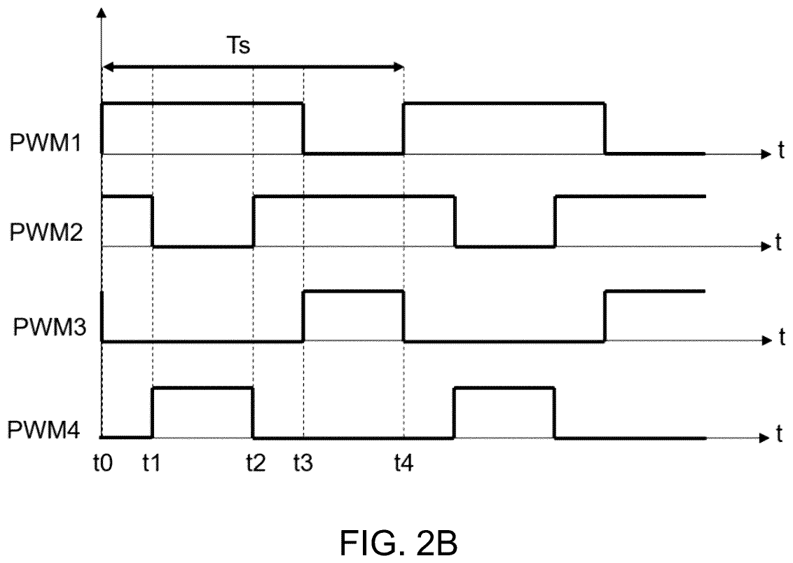

The application discloses a timing diagram of control signals as shown in FIG. 2A and FIG. 2B. A first control signal PWM1 is used for controlling the turn-on and turn-off of an upper switch Q1 and a middle switch Q4, a second control signal PWM2 is used for controlling the turn-on and turn-off of an upper switch Q3 and a middle switch Q2, a third control signal PWM3 is used for controlling the turn-on and turn-off of a second lower switch SR2 and a first lower switch SR3, and a fourth control signal PWM4 is used for controlling the turn-on and turn-off of the first lower switch SR1 and the second lower switch SR4. Wherein the duty ratios of the first control signal PWM1 and the second control signal PWM2 are equal, and staggered by 180 degrees; and the third control signal PWM3 is complementary to the first control signal PWM1, and the fourth control signal PWM4 is complementary to the second control signal PWM2.

Referring to FIG. 2A, the interval t0-t4 is a switching period, and the conduction duty ratio of the first control signal PWM1 and the second control signal PWM2 (equivalent to the duty ratio of the power conversion circuit, hereinafter referred to as the duty ratio) is less than or equal to 50%. Referring to FIG. 2B, the interval t0-t4 is one switching period, and the conduction duty ratio of the first control signal PWM1 and the second control signal PWM2 is greater than 50%; and the duty ratio required by the power conversion circuit is set through closed-loop control, and the purpose of stabilizing the output voltage is achieved. In fact, in order to prevent direct connection between corresponding switches which may cause damage to the power conversion device, and to achieve soft switching of each switch in the power conversion circuit, a certain dead time is set between the first control signal PWM1 and the third control signal PWM3 for each switch in the power conversion circuit, a certain dead time is set between the second control signal PWM2 and the fourth control signal PWM4, and dead time is ignored in FIG. 2A and FIG. 2B. In the embodiment, Q1 and Q2 are staggered by 180 degrees, so that the ripple current frequency flowing through the input capacitor Cin is 2 times of the frequency of the PWM1 or twice the frequency of the PWM2, so that the number and the size of the input capacitor Cin are greatly reduced.

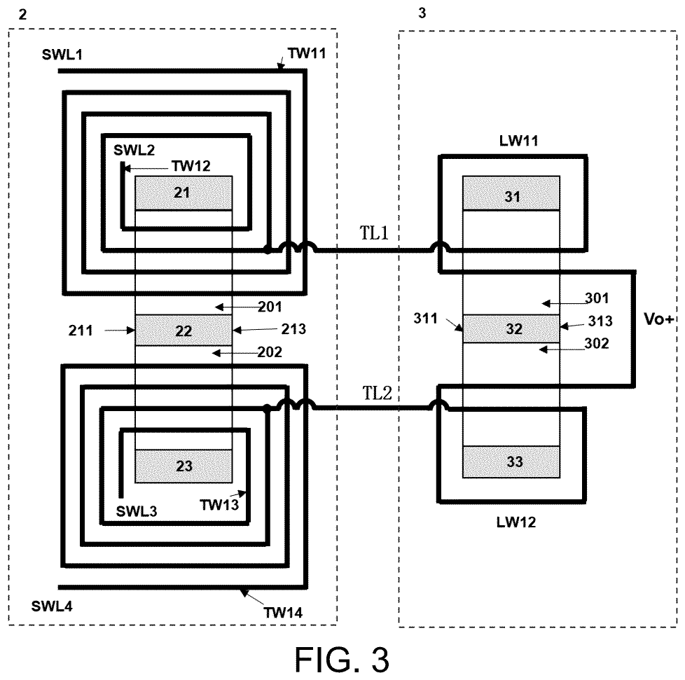

In the embodiment, the power conversion device is applied to the circuit topology shown in FIG. 1, and comprises a transformer assembly 2 and an inductor assembly 3 (the combination of the transformer assembly 2 and the inductor assembly 3 corresponds to the three-port magnetic unit), as shown in FIG. 3. The transformer assembly 2 comprises a transformer magnetic core assembly 20, a first transformer winding TW11 and TW12, and the second transformer winding TW13 and TW14. The inductor assembly 3 comprise an inductor magnetic core assembly 30, a first inductor winding LW11 and a second inductor winding LW12.

The transformer magnetic core assembly 20 comprises two transformer side columns 21 and 23, a transformer middle column 22 and two transformer magnetic substrates 24 and 25, wherein the transformer middle column 22 is arranged between the transformer side columns 21 and 23, and all the side columns and the middle column are arranged between the two magnetic substrates. A channel between the transformer side column 21 and the transformer middle column 22 is a first transformer channel 201, a channel between the transformer side column 23 and the transformer middle column 22 is a second transformer channel 202. The transformer magnetic core assembly 20 further comprises a first side surface 211 and a third side surface 213 opposite to each other, and a second side surface 212 and a fourth side surface 214 opposite to each other, and the first transformer channel 201 and the second transformer channel 202 penetrate through the first side surface 211 and the third side surface 213.

The first end (ie, the lower node SWL1) of the first transformer winding TW11, the first end of the first transformer winding TW12 (ie, the lower node SWL2), the first end of the second transformer winding TW13 (ie, the lower node SWL3) and the first end (ie, the lower node SWL4) of the second transformer winding TW14 are arranged adjacent to the first side surface 211; the second end of the first transformer winding TW11 and the second end of the first transformer winding TW12 (ie, the connection point TL1) and the second end of the second transformer winding TW13 and the second end (ie, the connection point TL2) of the second transformer winding TW14 are arranged adjacent to the third side surface 213. In the present embodiment, the first transformer winding TW11 is wound around the transformer side column 21 from the first end to the second end in a first direction (in the present embodiment in a clockwise direction), and passes through the first transformer channel 201 twice to reach the connection point TL1. The first transformer winding TW12 is wound around the transformer side column 21 from the first end to the second end in the second direction (in the present embodiment in a counterclockwise direction), and passes through the first transformer channel 201 twice to reach the connection point TL1. The second transformer winding TW13 is wound around the transformer side column 23 from the first end to the second end in a first direction (in the present embodiment in a clockwise direction) and passes through the second transformer channel 202 twice to reach the connection point TL2; the second transformer winding TW14 is wound around the transformer side column 23 from the first end to the second end in the second direction (in the present embodiment in a counterclockwise direction), and passes through the second transformer channel 202 twice to reach the connection point TL2.

In combination with the control signal timing diagrams shown in FIG. 2A and FIG. 2B, in this embodiment, the voltage waveform of the lower node SWL1 to the grounding point (ie, the input negative terminal Vin−, the followings are all taken as the ground point) is the same as the voltage waveform of the lower node SWL4 to the grounding point; and the voltage waveform of the lower node SWL2 to the grounding point is the same as the voltage waveform of the lower node SWL3 to the grounding point. In other words, the voltage waveform of the lower node SWL1 to the lower node SWL2 is the same as the voltage waveform of the lower node SWL4 to the lower node SWL3.

And also in combination with the control signal time sequence diagram shown in FIG. 2A and FIG. 2B, in the embodiment, the direction of the alternating current magnetic flux flowing out of the paper surface is a positive reference direction. The first transformer winding TW11 and the first transformer winding TW12 generate a first transformer alternating current magnetic flux on the transformer side column 21; and the second transformer winding TW13 and the second transformer winding TW14 generate a second transformer alternating current magnetic flux on the transformer side column 23. The first transformer alternating magnetic flux and the second transformer alternating magnetic flux have the same amplitude and opposite directions; therefore, the sectional areas of the transformer side columns 21 and 23 are the same. The first transformer alternating current magnetic flux and the second transformer alternating current magnetic flux are superposed in the transformer middle column 22 to generate a third transformer alternating current magnetic flux. Compared with the first transformer alternating magnetic flux and the second transformer alternating magnetic flux, the amplitude of the third transformer alternating magnetic flux is greatly reduced; therefore, the sectional area of the middle column in the transformer is smaller than that of the side column 21 or 23 in the transformer, and furthermore, the sectional area of the middle column in the transformer is smaller than 0.6 times of the sectional area of the side column 21 or 23 in the transformer. Thereby reducing the size of the transformer core assembly 20, or increasing the window area of the first transformer channel 201 and the second transformer channel 202 by reducing the cross-sectional area of the column in the transformer.

The inductor magnetic core assembly 30 comprises two inductor side columns 31 and 33, an inductor middle column 32 and two inductor magnetic substrates 34 and 35, wherein the inductor middle column 32 is arranged between the inductor side columns 31 and 33, and all the side columns and the middle column are arranged between the two magnetic substrates. A channel arranged between the inductor side column 31 and the inductor middle column 32 is a first inductor channel 301, and a channel arranged between the inductor side column 33 and the inductor middle column 32 is a second inductor channel 302. The inductor magnetic core assembly further comprises a first side surface 311 and a third side surface 313 which are opposite to each other and a second side surface 312 and a fourth side surface 314 which are opposite to each other; the first inductor channel 301 and the second inductor channel 302 penetrate through the first side surface 311 and the third side surface 313.

In the embodiment, the first side surface 311 of the inductor assembly 30 is arranged adjacent to the third side surface 213 of the transformer assembly 20. A first end (equivalent to a connection point TL1) of the first inductor winding LW11 and a first end (equivalent to a connection point TL2) of the second inductor winding LW12 are arranged adjacent to the first side surface 311, and a second end of the first inductor winding LW11 and a second end (equivalent to an output positive terminal Vo+) of the second inductor winding LW12 are arranged adjacent to the third side surface 313. The first inductor winding LW11 is wound around the inductor side column 31 from the first end to the second end in the second direction (in the embodiment, the counterclockwise direction), and the first inductor winding LW11 passes through the first inductor channel 301 twice; the second inductor winding LW12 is wound around the inductor side column 33 from the first end to the second end in the first direction (in the embodiment, the clockwise direction), and the second inductor winding LW12 passes through the second inductor channel 302 twice.

In combination with the control signal time sequence diagram shown in FIG. 2A and FIG. 2B, in the embodiment, the direction of the magnetic flux flowing out of the paper surface is a positive reference direction, and the amplitude of the voltage waveform from the first end to the second end of the first inductor winding LW11 is the same as the amplitude of the voltage waveform from the first end to the second end of the second inductor winding LW12, and the two waveforms are in the same direction.

Similarly, in combination with the control signal time sequence diagram shown in FIG. 2A and FIG. 2B, in the embodiment, the first inductor winding LW11 generates a first inductor magnetic flux on the inductor side column 31, and the second inductor winding LW12 generates a second inductor magnetic flux on the inductor side column 33; the first inductor magnetic flux comprises a first inductor alternating current magnetic flux and a first inductor direct current magnetic flux; and the second inductor magnetic flux comprises a second inductor alternating current magnetic flux and a second inductor direct current magnetic flux. The first inductor magnetic flux and the second inductor magnetic flux are superposed in the inductor middle column 32 to generate a third inductor magnetic flux. Compared with a first inductor magnetic flux or a second inductor magnetic flux, the amplitude of the third inductor magnetic flux is greatly reduced; therefore, the sectional area of the inductor middle column 32 is smaller than the sectional area of the inductor side column 31 or 33, and furthermore, the sectional area of the inductor middle column 32 is smaller than 0.6 times of the sectional area of the inductor side columns 31 or 33. Therefore, the size of the inductor magnetic core assembly 30 is reduced, or the window area of the first inductor channel 301 and the window area of the second inductor channel 302 are increased by reducing the cross-sectional area of the middle column in the inductor.

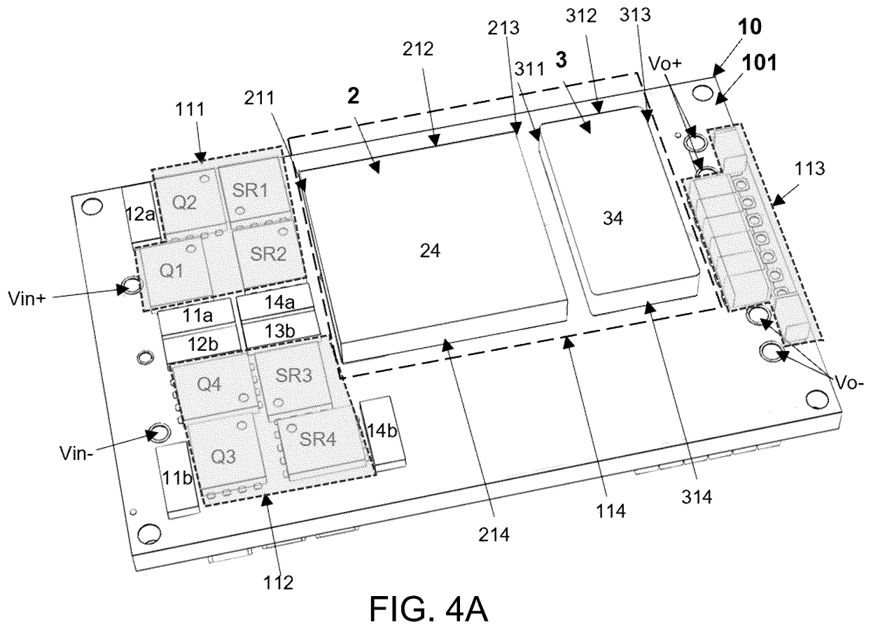

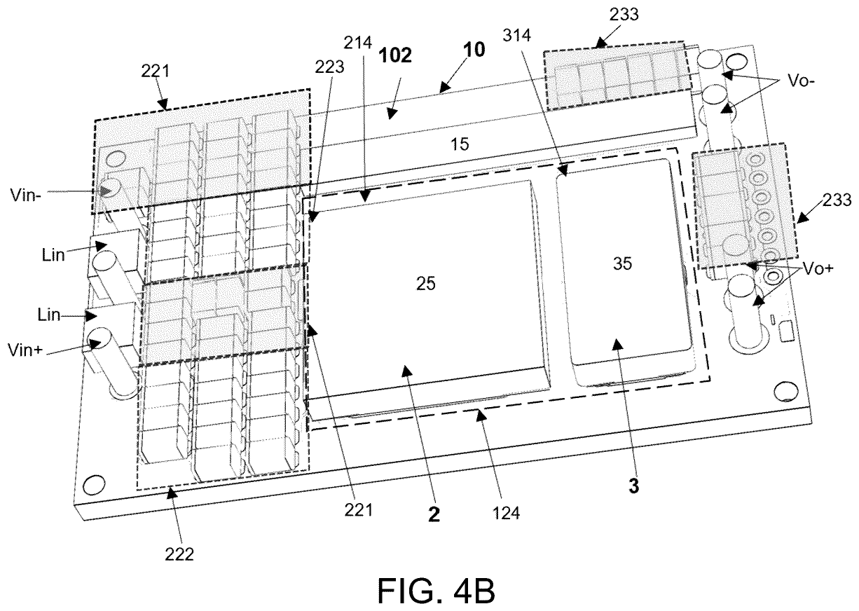

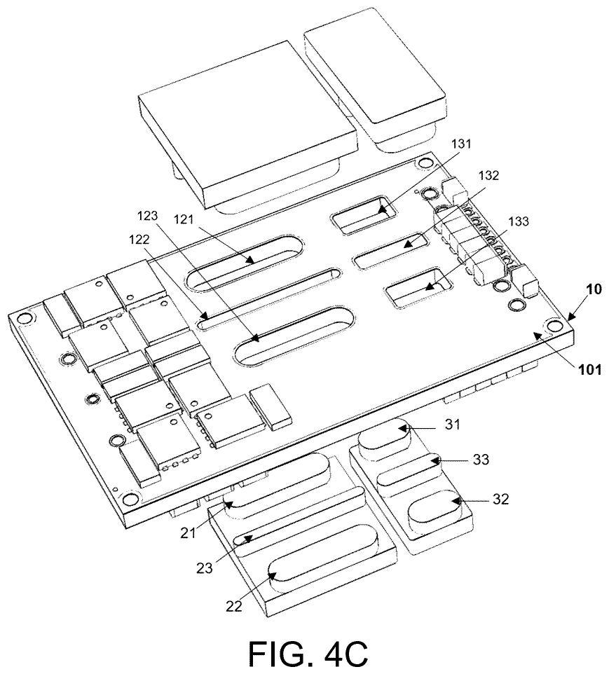

The application discloses a layout diagram of a power conversion device, as shown in FIGS. 4A to 4C. FIG. 4A is a schematic perspective top view of the power conversion device, FIG. 4B is a bottom view of the power conversion device, and FIG. 4C is a top exploded view of the power conversion device. The embodiment can apply the circuit topology shown in FIG. 1, the control time sequence of FIG. 2A and/or FIG. 2B, or the winding mode of the winding shown in FIG. 3. As shown in FIG. 4A, the power conversion device comprises a circuit substrate 10, a transformer assembly 2, an inductor assembly 3, a plurality of switch elements, a plurality of heat dissipation metal blocks, an output capacitor Co, an input capacitor Cin, an input positive terminal Vin+, an input negative terminal Vin−, an output positive terminal Vo+ and an output negative terminal Vo−.

The circuit substrate 10 comprises an upper surface 101 and a lower surface 102 opposite to each other, the magnetic assembly area 114 is arranged on the upper surface 101, the magnetic assembly area 124 is arranged on the lower surface 102, and the magnetic assembly areas 124 and 114 are correspondingly arranged. The hole grooves 121/122/123 and the hole grooves 131/132/133 are arranged in the magnetic assembly area, the hole grooves 121/122/123 penetrating through the upper surface 101 and the lower surface 102 are respectively used for the transformer side column 21, the transformer middle column 22 and the transformer side column 23 to penetrate through, and the hole grooves 131/132/133 are respectively used for the inductor side column 31, the inductor middle column 32 and the inductor side column 33 to pass through.

The switch regions 111 and 112 are both disposed on the upper surface 101 and are disposed adjacent to the first side surface 211 of the transformer core assembly; the switch area 111 is arranged between the input positive pin Vin+ and the transformer magnetic core assembly and is adjacent to the transformer side column 21 and used for arranging the switch elements Q1/Q2/SR1/SR2 in the circuit unit A1. In the embodiment, the switches Q1, Q2 and SR1 are sequentially placed in the clockwise direction, and specifically, the source electrode of the upper switch Q1 is adjacent to and electrically connected with the drain electrode of the middle switch Q2; the source electrode of the middle switch Q2 is adjacent to and electrically connected to the drain electrode of the first lower switch SR1; the source electrode of the first lower switch SR1 is adjacent to and shorted to the source electrode of the second lower switch SR2; the drain electrode of the first lower switch SR1 is arranged adjacent to a first end (equivalent to a lower node SWL1) of the first transformer winding TW11, and the drain electrode of the second lower switch SR2 is arranged adjacent to a first end (equivalent to a lower node SWL2) of the first transformer winding TW12; therefor the wiring path of the power path is shortened, and the conduction loss of the power path is reduced. The switch region 112 is arranged between the input negative pin Vin− and the transformer magnetic core assembly, and is arranged adjacent to the transformer side column 23 and is used for arranging the switch elements Q3/Q4/SR3/SR4 in the circuit unit A2. In the embodiment, the switches Q3, Q4 and SR3 are arranged in a clockwise direction in the clockwise direction, and specifically, the source electrode of the upper switch Q3 is adjacent to and electrically connected with the drain electrode of the middle switch Q4; the source of the middle switch Q4 is adjacent to and electrically connected with the drain electrode of the first lower switch SR3; the source of the first lower switch SR3 is adjacent to and shorted to the source of the second lower switch SR4; the drain of the first lower switch SR3 is disposed adjacent to the first end (ie, the lower node SWL3) of the second transformer winding TW13, and the drain of the second lower switch SR4 is disposed adjacent to the first end (ie, the lower node SWL4) of the second transformer winding TW14; wherein the wiring path of the power path is shortened, and the conduction loss of the power path is reduced. In other embodiments, switches Q1, Q2, SR1, and SR2 may be modified to be placed sequentially in a counterclockwise direction; and in this case, the switches Q3, Q4, and SR3 are also correspondingly modified to be placed sequentially in a counterclockwise direction; when the switch is placed counterclockwise, the clockwise winding direction of the first transformer winding from the lower node SWL1 to the SWL2 is correspondingly modified to the counterclockwise winding direction, and the clockwise winding direction of the second transformer winding from the lower node SWL3 to the SWL4 is correspondingly modified to the counterclockwise winding direction; so that the drain electrode of the first lower switch SR1 is arranged adjacent to the first end (the lower node SWL1) of the first transformer winding TW11, and the drain electrode of the second lower switch SR2 is arranged adjacent to the first end (the lower node SWL1) of the first transformer winding TW12, so that the drain electrode of the first lower switch SR3 is arranged adjacent to the first end (the lower node SWL3) of the second transformer winding TW13, and the drain electrode of the second lower switch SR4 is arranged adjacent to the first end (the lower node SWL4) of the second transformer winding TW14; and the benefits of shortening the wiring path of the power path and reducing the conduction loss are continuously obtained.

On the upper surface 101, the output area 113 is arranged adjacent to the third side surface 313 of the inductor magnetic core assembly, and the output area 113 is adjacent to the output positive terminal Vo+ and/or the output negative terminal Vo−, and is used for setting the output capacitor Co.

In the embodiment, four circles of windings wound around the transformer side column 21 can be arranged through wiring in the circuit substrate 10 in two circles, and one circle realized through the copper foil arranged on the upper surface 101 of the circuit substrate 10, and one circle realized through the copper foil arranged on the lower surface 102; and in conclusion, a sum of four circles is obtained. Similarly, four circles of windings wound around the transformer side column 23 can also be realized in the same embodiment. Two circles of windings wound around the inductor side column 31 can be arranged in a circle through the internal wiring of the circuit substrate 10, and the copper foils arranged on the upper surface 101 and the lower surface 102 of the circuit substrate 10 are connected in parallel to form a circle; and in conclusion, a sum of two circles is obtained. Similarly, the two windings wound around the inductor side column 33 can also be implemented in the same embodiment.

At lower surface 102, the input capacitor region 221, the flying capacitor C1 region 222 and the flying capacitor C2 region 223 are arranged between the input end and the first side surface 211 of the transformer magnetic core assembly, from the input positive terminal Vin+ to the input negative terminal Vin− along the first side surface 211, a flying capacitor C1 area 222, an input capacitor area 221, a flying capacitor C2 area 223 and an input capacitor area 221 are arranged in sequence; the flying capacitor C1 is arranged in the flying capacitor C1 area 222, and is adjacent to the source electrode of the upper switch Q1 and the drain electrode of the second lower switch SR2, so that the flying capacitor C1 is connected between the source electrode of the upper switch Q1 and the drain electrode of the second lower switch SR2 nearby. The flying capacitor C2 is arranged in the flying capacitor C2 area 223, and is adjacent to the source electrode of the upper switch Q3 and the drain electrode of the second lower switch SR4, so that the flying capacitor C2 is connected between the source electrode of the upper switch Q3 and the drain electrode of the second lower switch SR4 nearby. An input capacitor Cin arranged in the input capacitor area 221 (adjacent to the input positive terminal Vin+) is connected between the drain electrode of the upper switch Q1 and the source electrode of the second lower switch SR2 nearby or between the drain electrode of the upper switch Q3 and the source electrode of the second lower switch SR4 nearby. The output area 233 is arranged adjacent to the third side surface 313 of the inductor magnetic core assembly and is arranged adjacent to the output positive terminal Vo+ and/or the output negative terminal Vo−. The output area 233 is used for setting an output capacitor Co, and the output capacitor Co is connected between the output positive terminal Vo+ and the output negative terminal Vo− of the module nearby. After the two input inductors Lin are connected in parallel, the two input inductors Lin are connected between the input positive terminal Vin+ and the drain electrode of the upper switch Q1 or the drain electrode of the upper switch Q1 nearby.

In the embodiment, a plurality of metal blocks is arranged on the upper surface 101 and the lower surface 102. On the upper surface 101, the heat dissipation metal blocks 11a, 12a and 14a are respectively adjacent to the drain electrode of the upper switch Q1, the drain electrode of the middle switch Q2 and the drain electrode of the second lower switch SR2; the height of the metal blocks is approximately equal to the height of the switch, and the metal blocks are used for increasing the contact area of the switch heat source and the additional heat dissipation fins so as to help dissipate the heat of the switch drains; and the drain electrode of the first lower switch SR1 dissipates the heat through the copper foil arranged on the upper surface of the first transformer winding TW11. The heat dissipation metal blocks 11b, 12b, 13b and 14b are respectively adjacent to the drain electrode of the upper switch Q3, the drain electrode of the middle switch Q4, the drain electrode of the first lower switch SR3 and the drain electrode of the second lower switch SR4. The heights of the metal blocks are approximately equal to the height of the switch, and are used for increasing the contact area between the switch heat source and the external heat dissipation fins, thereby helping to dissipate the heat of the switch drain electrodes. On the lower surface 102, the metal block 15 is arranged adjacent to the fourth side surface 114 of the transformer magnetic core component and the fourth side surface 214 of the inductor magnetic core component, and the input negative network and the output negative network on the two sides of the magnetic component area are short-circuited, so that the electrical connection between the input negative network and the output negative network is realized, the parasitic resistance of the PCB is reduced, and the loss is reduced. In the embodiment, the metal block can be made of copper metal, and in other embodiments, other heat conduction or conductive metal can also be adopted.

In other embodiments, only transformer magnetic components may be included in the magnetic component regions 114 and 214.

The switch tube disclosed by the application can be used for realizing the functions of the switch disclosed by the application, such as a Si MOSFET, SiC MOSFET, GaN MOSFET or IGBT MOSFET.

The power conversion device according to the embodiment can be an independent module or a part of the electronic device, and can meet the technical features and advantages disclosed by the application.

The “equal” or “same” or “equal to” disclosed by the application needs to consider the parameter distribution of engineering, and the error distribution is within +/−30%; and the included angle between the two line segments or the two straight lines is less than or equal to 45 degrees; the included angle between the two line segments or the two straight lines is within the range of [60, 120]; and the definition of the phase error phase also needs to consider the parameter distribution of the engineering, and the error distribution of the phase error degree is within +/−30%.

The embodiments in the specification are described in a progressive manner, each embodiment focuses on the difference from other embodiments, and the same similar parts between the embodiments can be referred to each other.

The above description of the disclosed embodiments enables a person skilled in the art to implement or use the present application. Various modifications to these embodiments will be readily apparent to those skilled in the art, and the generic principles defined herein may be implemented in other embodiments without departing from the spirit or scope of the application. Thus, the present application will not be limited to the embodiments shown herein but is to be accorded the widest scope consistent with the principles and novel features disclosed herein.

What is claimed is:

1. A power conversion device, comprising an input positive terminal, an input negative terminal, an output positive terminal, an output negative terminal and a circuit unit, wherein the circuit unit comprises a first circuit unit and a second circuit unit;
the first circuit unit and the second circuit unit are electrically connected in parallel and bridged between the input positive terminal and the input negative terminal; and each circuit unit comprises an upper switch, a middle switch, a first lower switch, a second lower switch, a three-port magnetic assembly and a flying capacitor; the upper switch and the middle switch are electrically connected to an upper node, and the upper switch is bridged between the input positive terminal and the upper node; the middle switch and the first lower switch are electrically connected to a first lower node, and the first lower switch is bridged between the first lower node and the input negative terminal; the flying capacitor and the second lower switch are electrically connected to a second lower node, the second lower switch is bridged between the input negative terminal and the second lower node, and the flying capacitor is bridged between the upper node and the second lower node; the three-port magnetic assembly is electrically connected with the first lower node, the second lower node and the output positive terminal;
further comprising a group of control signals, wherein the group of control signals comprises a first control signal, a second control signal, a third control signal and a fourth control signal; the first control signal is used for controlling turn-on and turn-off of the upper switch of the first circuit unit and the middle switch of the second circuit unit; the second control signal is used for controlling turn-on and turn-off of the middle switch of the first circuit unit and the upper switch of the second circuit unit; the third control signal is used for controlling turn-on and turn-off of the second lower switch of the first circuit unit and the first lower switch of the second circuit unit; the fourth control signal is used for controlling turn-on and turn-off of the first lower switch of the first circuit unit and the second lower switch of the second circuit unit;
the first control signal and the second control signal are staggered by 180 degrees, the third control signal is complementary to the first control signal, and the fourth control signal is complementary to the second control signal.

2. The power conversion device of claim 1, wherein a duty ratio of each control signal is any value between 0 and 1.

3. The power conversion device of claim 1, wherein the three-port magnetic assembly comprises two transformer windings and an inductor winding; first ends of the two transformer windings are electrically connected to the first lower node and the second lower node of the circuit unit respectively, second ends of the two transformer windings are electrically connected to a first end of the inductor winding, and a second end of the inductor winding is electrically connected to the output positive terminal.

4. The power conversion device of claim 1, wherein the three-port magnetic assembly comprises two transformer windings; first ends of the two transformer windings are electrically connected to the first lower node and the second lower node of the circuit unit respectively, and second ends of the two transformer windings are electrically connected to the output positive terminal respectively.

5. The power conversion device of claim 3, wherein the first end of one transformer winding in each three-port magnetic assembly and the second end of the other transformer winding are dotted terminals.

6. The power conversion device of claim 3, further comprising a transformer magnetic core and an inductor magnetic core; and the transformer magnetic core comprises two transformer side columns, a transformer middle column and two transformer magnetic substrates; the two transformer side columns and one transformer middle column are arranged between the two transformer magnetic substrates, and the transformer middle column is arranged between the two transformer side columns; and the inductor magnetic core comprises two inductor side columns, an inductor middle column and two inductor magnetic substrates; the two inductor side columns and one inductor middle column are arranged between the two inductor magnetic substrates, and the inductor middle column is arranged between the two inductor side columns; the first end of one transformer winding and the first lower switch are electrically connected to the first lower node, the first end of the other transformer winding and the second lower switch are electrically connected to the second lower node, and the second ends of the two transformer windings are short-circuited; and the two transformer windings in each circuit unit are wound around one transformer side column in the same direction from the first lower node to the second lower node; and the inductor winding in the first circuit unit is wound around one inductor side column in a first direction, and the inductor winding in the second circuit unit is wound around the other inductor side column in a second direction.

7. The power conversion device of claim 6, wherein sectional areas of the two transformer side columns are the same, and the sectional area of the transformer middle column is smaller than that of the transformer side column; sectional areas of the two inductor side columns are the same, and the sectional area of the inductor middle column is smaller than that of the inductor side column.

8. The power conversion device of claim 7, wherein the sectional area of the transformer middle column is smaller than 0.6 times of the sectional area of the transformer side column; and the sectional area of the inductor middle column is smaller than 0.6 times of the sectional area of the inductor side column.

9. A power conversion device, comprising a circuit substrate, an input end, an output end, a switch element, a magnetic assembly and a metal block; the input end comprises an input positive terminal and an input negative terminal, and the output end comprises an output positive terminal and an output negative terminal; the magnetic assembly comprises a winding and a magnetic core, and the winding is arranged in the circuit substrate and/or on a surface of the circuit substrate; the magnetic assembly is bridged between the input end and the output end through the switch element; the metal block is arranged on the surface of the circuit substrate and is in short connection with the input negative terminal and the output negative terminal, and the magnetic assembly is arranged between the input end and the output end;
the metal block is disposed adjacent to one side of the magnetic assembly.

10. The power conversion device of claim 9, further comprising a heat dissipation metal block arranged on the surface of the circuit substrate and arranged adjacent to a drain electrode of the switch element and used for dissipating heat generated by the switch element.

11. The power conversion device of claim 10, wherein a height of the metal block and/or the heat dissipation metal block is equal to a height of the switch element.

12. The power conversion device of claim 10, wherein the metal block and/or the heat dissipation metal block are copper materials.

13. A power conversion device, comprising a circuit substrate, a circuit unit, an input end and an output end; the circuit unit comprises a first circuit unit and a second circuit unit; each circuit unit comprises an upper switch, a middle switch, a first lower switch and a three-port magnetic assembly; the upper switch, the middle switch and the first lower switch of each circuit unit are sequentially connected in series; the input end comprises an input positive terminal and an input negative terminal, and the output end comprises an output positive terminal and an output negative terminal;
the circuit substrate comprises an upper surface and a lower surface which are opposite to each other, and the upper surface comprises a switch area and a magnetic assembly area; the switch area is used for arranging the upper switch, the middle switch and the first lower switch, and the magnetic assembly area is used for arranging the three-port magnetic assembly;
the input end, the switch area, the magnetic assembly area and the output end are sequentially arranged in the same direction;
the upper switch, the middle switch and the first lower switch in each circuit unit are sequentially arranged in the same direction; and each first lower switch is arranged adjacent to the magnetic assembly area.

14. The power conversion device of claim 13, wherein each circuit unit further comprises a second lower switch, and a source electrode of the second lower switch is connected with a source electrode of the first lower switch in parallel; and the second lower switch is arranged in the switch area and is arranged adjacent to the magnetic assembly area.

15. The power conversion device of claim 14, wherein the upper switch, the middle switch, the first lower switch and the second lower switch in each circuit unit are sequentially arranged in the same direction.

16. The power conversion device of claim 13, wherein the upper surface further comprises an output area, the output area is used for setting an output capacitor, and the output area is arranged adjacent to the output end.

17. The power conversion device of claim 13, wherein the lower surface comprises an input capacitor area, a flying capacitor area, a magnetic assembly area and an output area; the input capacitor area is used for setting an input capacitor, the flying capacitor area is used for setting a flying capacitor, the magnetic assembly area is used for arranging a three-port magnetic assembly, and the output area is used for setting an output capacitor; the input end, the magnetic assembly area and the output area are sequentially arranged in the same direction on the lower surface; the input capacitor area and the flying capacitor area are both arranged between the input end and the magnetic assembly area; and the input capacitor area of the first circuit unit, the flying capacitor area of the first circuit unit, the input capacitor area of the second circuit unit and the flying capacitor area of the second circuit unit are sequentially arranged in the direction from the input positive terminal to the input negative terminal.

18. The power conversion device of claim 14, wherein each three-port magnetic assembly comprises two transformer windings; and the three-port magnetic assembly share one transformer magnetic core; and the transformer magnetic core comprises two transformer side columns, a transformer middle column and two transformer magnetic substrates; the two transformer side columns and one transformer middle column are arranged between the two transformer magnetic substrates, and the transformer middle column is arranged between the two transformer side columns; a first end of one transformer winding and the first lower switch are electrically connected to a first lower node, a first end of the other transformer winding and the second lower switch are electrically connected to a second lower node, and second ends of the two transformer windings are short-circuited; and the two transformer windings in each circuit unit are wound around one transformer side column in the same direction from the first lower node to the second lower node respectively.

19. The power conversion device of claim 18, wherein the first lower switch and the second lower switch in the same circuit unit are arranged close to the same transformer side column.

20. The power conversion device of claim 18, wherein the arrangement direction of the upper switch, the middle switch and the first lower switch in each circuit unit is the same as a winding direction of the two transformer windings around a side column from the first lower node to the second lower node.

21. The power conversion device of claim 18, wherein each three-port magnetic assembly further comprises an inductor winding, and two inductor windings share one inductor magnetic core; and each inductor winding is bridged between a connection point of the transformer windings and the output positive terminal; the inductor magnetic core comprises two inductor side columns, an inductor middle column and two inductor magnetic substrates; the two inductor side columns and one inductor middle column are arranged between the two inductor magnetic substrates, and the inductor middle column is arranged between the two inductor side columns; and the inductor winding in the first circuit unit is wound around one inductor side column in a first direction, and the inductor winding in the second circuit unit is wound around the other inductor side column in a second direction.
